(19) United States
(12) Patent Application Publication
(10) Pub. No.: US 2011/0247780 A1
(43) Pub. Date: Oct. 13, 2011

(54) ELECTRONIC SYSTEM COOLER

(75) Inventor: William H. Scofield, Batavia, IL (US)

(73) Assignee: Alcatel-Lucent USA, Incorporated, Murray Hill, NJ (US)

(21) Appl. No.: 12/758,674

(22) Filed: Apr. 12, 2010

(51) Int. Cl. F24J 3/08; B23P 11/00; F28F 13/12; F28D 15/00; F25D 17/02

(52) U.S. Cl. 165/45; 165/104.31; 62/434; 165/109.1; 29/428

(57) ABSTRACT

A cooling system includes a heat exchanger, a refrigerant reservoir and a pump. The pump is connected to the heat exchanger by a first line. A second line connects the heat exchanger to the reservoir. A third line connects the reservoir to the pump. The third line has an opening within the reservoir that is below an opening of the second line within the reservoir. The first, second and third lines are capable of carrying a refrigerant.

### TECHNICAL FIELD

This application is directed, in general, to cooling systems.

### BACKGROUND

An electronic system generates heat that, unless removed, increases the temperature of components within the system. If allowed to rise too high, the temperature may reduce the operating life of some components, and in some cases may result in loss of a service provided by the electronic system. The heat may thus be removed by a cooling system to an external environment.

### SUMMARY

One embodiment provides a cooling system. The cooling system includes a heat exchanger, a refrigerant reservoir and a pump. A first line connects the pump to the heat exchanger. A second line connects the heat exchanger to the reservoir. A third line connects the reservoir to the pump. The first, second and third lines are capable of carrying a refrigerant. The third line has an opening within the reservoir that is below an opening of the second line within the reservoir.

Another embodiment provides a method. The method includes configuring a heat exchanger to absorb heat from a heat source. The configuring includes connecting the heat exchanger to a pump via a first refrigerant line, and to a refrigerant reservoir via a second refrigerant line. The configuring further includes connecting the reservoir to the pump via a third refrigerant line. The third line has an opening within the reservoir that is below an opening of the second line within the reservoir. The first, second and third lines are capable of carrying a refrigerant.

In another embodiment, a cooling system includes a primary cooling loop. The primary cooling loop includes a first and a second heat exchanger, a refrigerant reservoir and a pump, and first, second and third refrigerant lines. The first line connects the pump to the first heat exchanger. The second heat exchanger is connected to the first heat exchanger by the second line, and to the pump by the third line. A refrigerant reservoir is located in the third refrigerant line between the second heat exchanger and the pump. The reservoir has a first opening at an inlet thereof that is above a second opening at an outlet thereof. The first, second and third lines are configured to circulate a refrigerant. The second heat exchanger is configured to transfer heat from the refrigerant to a secondary cooling loop.

### BRIEF DESCRIPTION

Reference is now made to the following descriptions taken in conjunction with the accompanying drawings, in which:

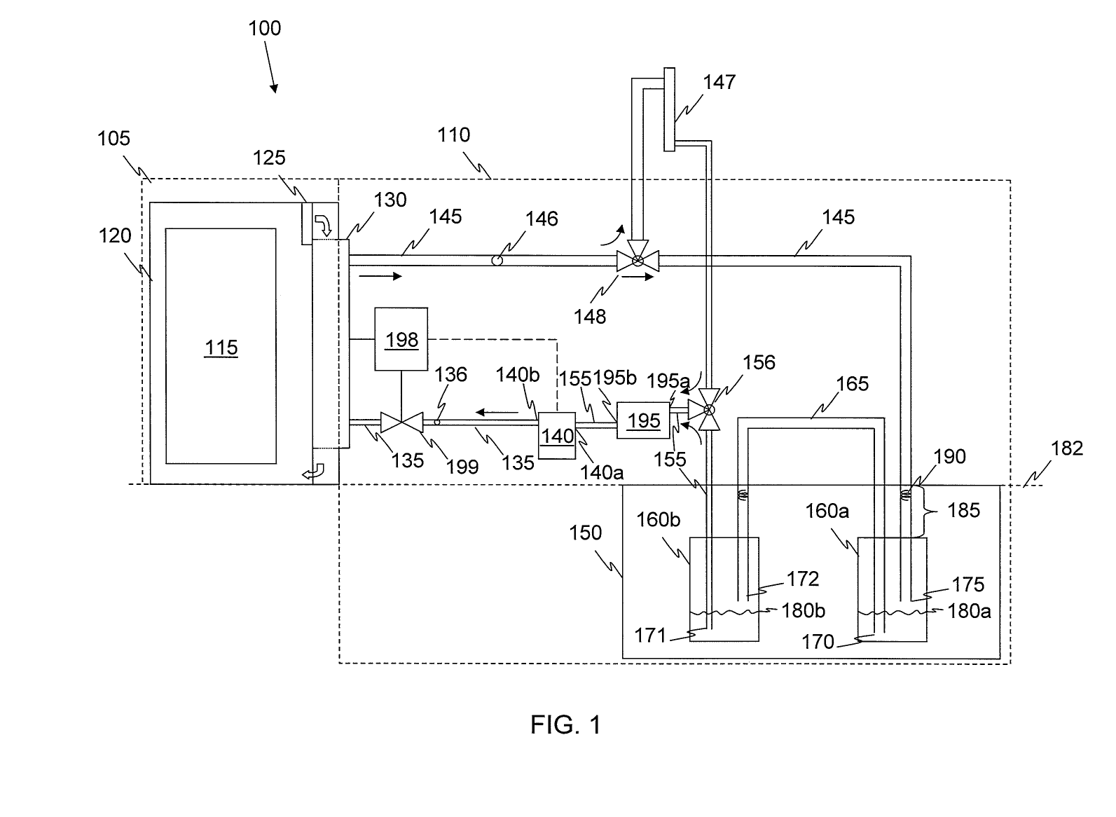

FIG. 1 illustrates an embodiment of a cooling system configured to cool heat-producing equipment;

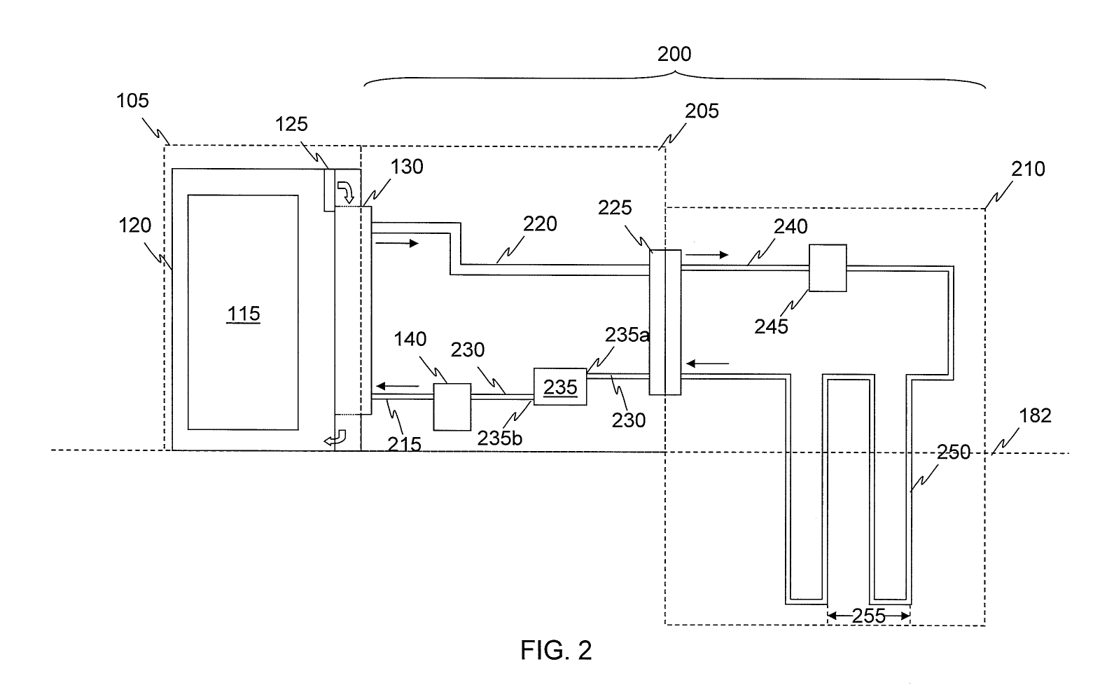

FIG. 2 illustrates an embodiment of a cooling system configured to transfer heat from a primary cooling loop that includes a refrigerant to a secondary cooling loop;

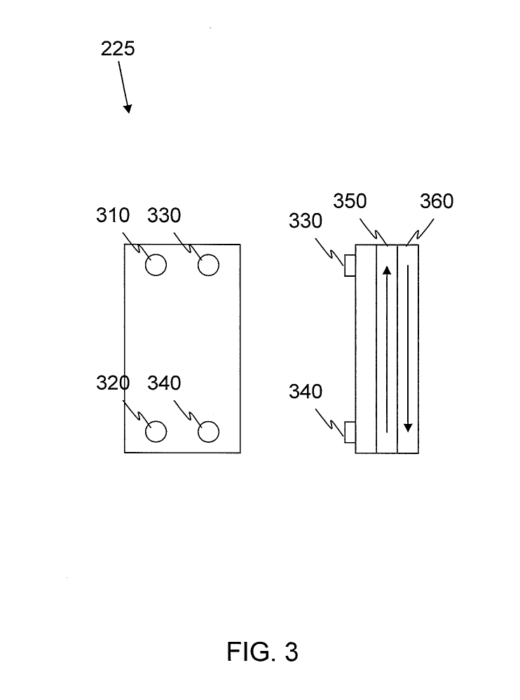

FIG. 3 schematically illustrates a heat exchanger that may transfer heat between the primary and secondary cooling loops of FIG. 2; and

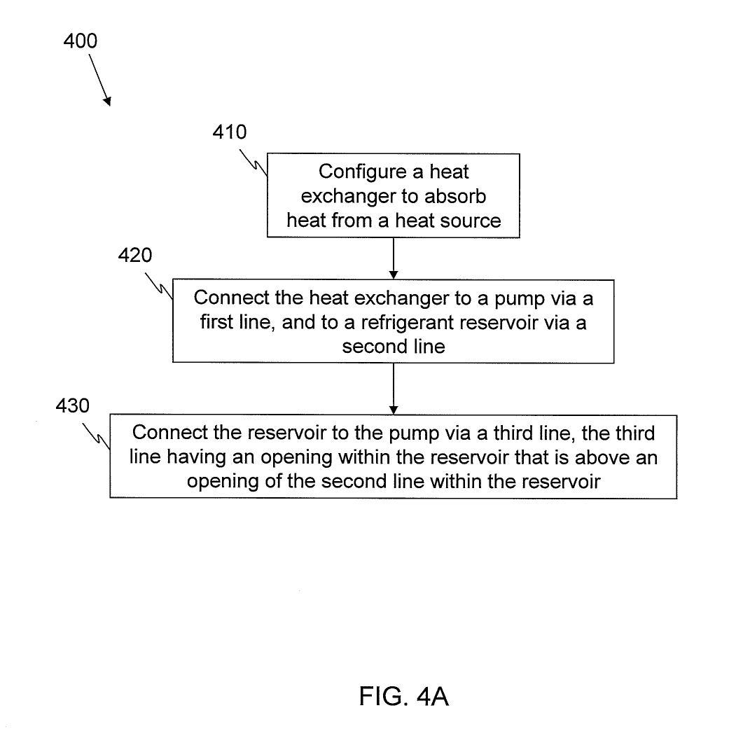

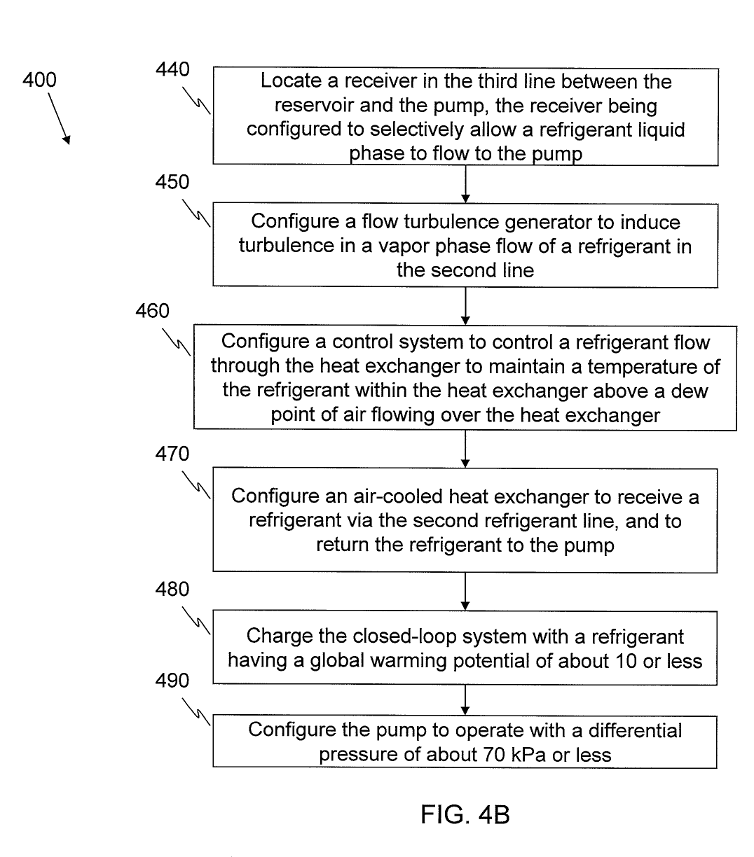

FIGS. 4A and 4B present a method that may be used to fabricate a cooling system, e.g., the cooling system of FIG. 1.

### DETAILED DESCRIPTION

Turning to FIG. 1, illustrated is an embodiment of a system 100. The system 100 includes an electronic system 105 and a cooling system 110. The electronic system 105 includes components 115 that generate heat when operating. The components 115 may be located within an enclosure 120. A fan 125 may circulate air within the enclosure through a heat exchanger 130. In various embodiments the heat exchanger 130 is a micro-channel heat exchanger.

The cooling system 110 includes the heat exchanger 130 and various components configured to transport heat therefrom. A first refrigerant line 135 connects a pump 140 to the heat exchanger 130. A second refrigerant line 145 connects the heat exchanger 130 to a refrigerant reservoir 150. And a third refrigerant line 155 connects the refrigerant reservoir 150 to the pump 140. The heat exchanger 130, pump 140, reservoir 150, first line 135, second line 145, and third line 155 form a closed-loop cooling system configured to circulate a refrigerant. In various embodiments, and as illustrated, the second line 145 has a cross-sectional area 146 greater than a cross sectional area 136 of the first line 135. This aspect is discussed further below. The third line 155 may optionally have a cross section area about equal to the cross-sectional area of the first line 135.

The refrigerant is not limited to any particular type, but is selected from those chemicals recognized by those skilled in the pertinent art as having utility in refrigeration applications. Without limitation, this class of chemicals includes those which are capable of changing phase from liquid to gas when exposed to the heat generated by the electronics and may include hydrocarbons, chlorocarbons, fluorocarbons, chlorofluorocarbons (CFCs), ammonia and CO₂. In some advantageous embodiments, the refrigerant is a non-ozone-depleting chemical, such as those of the described class that do not include chlorine. Non-ozone depleting refrigerants may be characterized as having an ozone depletion potential (ODP) of zero. An example chlorine-free refrigerant is R134a, with a chemical formula CH₂F—CF₃. In some other advantageous embodiments, the refrigerant has a low global warming potential (GWP). Those skilled in the pertinent art will appreciate that CO₂ is assigned a GWP of unity. Another chemical may be characterized by a GWP that represents the potential for that chemical to contribute to global warming, relative to the effect of CO₂. One nonlimiting example of a refrigerant that is chorine-free and has a low GWP is 2,3,3,3-tetrafluoroprop-1-ene, sometimes referred to as HFO-1234yf, available from various manufacturers, including Honeywell International, Inc, Morristown, N.J. 07962, USA. HFO-1234yf is regarded as having a GWP between about 4 and about 6.

The refrigerant is circulated by the pump 140. The pump is configured to receive liquid refrigerant at an input 140a, and output liquid refrigerant at an output 140b. The pressure differential between the output 140b and in the input 140a need only be sufficient to overcome drag between the refrigerant and the various paths through which the refrigerant passes, and to lift the refrigerant through any vertical paths in the cooling system 110. This aspect is discussed in greater detail below. In various embodiments, the pump 140 produces a pressure differential between the output 140b and the input 140a of about 70 kPa (e.g., about 10 PSI) or less. When the pressure differential is at or below about 70 kPa, the refrigerant is negligibly compressed. When the closed loop path length and/or the height of any vertical paths is relatively short, a pressure differential substantially less than 70 kPa, e.g., about 30 kPa, may be sufficient to circulate the refrigerant.

The configuration of the pump 140 is markedly different than a compressor would be configured in a conventional refrigeration loop. In a conventional refrigeration loop, a gaseous refrigerant is typically compressed by the compressor to produce liquid refrigerant, or a mixture of liquid and gaseous refrigerant, at an output of the compressor. The pressure differential between the input and the output of the compressor is typically on the order of 700 kPa or more, e.g., at least about an order of magnitude greater than for the pump 140. The compression cycle consumes a significant amount of energy. Moreover, the compressor usually cannot receive a liquid at its input, as liquids are practically incompressible.

In contrast to a compressor, the pump 140 produces a much lower pressure differential. The refrigerant is circulated through the heat exchanger 130, in which the refrigerant absorbs heat from the air that is co-circulated through the heat exchanger 130. In some embodiments, discussed further below, some of the refrigerant vaporizes within the heat exchanger 130, thereby absorbing heat as determined in part by the heat of vaporization characteristic of the chemical used as the refrigerant. Thus, the heat extracted by the refrigerant is significantly greater than if the refrigerant were not converted to the vapor phase.

The cross-sectional area of the second line 145 may be greater than the cross-sectional area of the first line 135 to accommodate the difference in volume of the gaseous refrigerant. For convenience of discussion an “area ratio” is defined as the cross-sectional area 146 divided by the cross-sectional area 136.

A conventional refrigeration loop may include a high-pressure side, a low-pressure side and a throttle valve isolating the two sides. High pressure produced by a compressor causes refrigerant vapor in the high-pressure side to flow, but at the expense of a large amount of power. However, unlike a conventional refrigeration loop some embodiments herein operate with a very small pressure differential, e.g. sufficient to circulate the refrigerant. Such operation is expected to consume significantly less power than a conventional refrigerant loop, providing significant benefit to power-sensitive installations, such as a remote antenna site.

In embodiments in which the area ratio is about unity, the pressure within the second line 145 would rise in response to the conversion of liquid refrigerant to vapor. This pressure rise would be expected to cause the pump 140 to work harder to circulate the refrigerant, undesirably consuming additional power.

In some embodiments the area ratio is advantageously larger than unity. In some embodiments the area ratio is at least 2. When this is the case, the work needed to circulate the refrigerant is expected to be significantly reduced relative to embodiments having an area ratio of unity. In some cases it may be advantageous to further reduce the pressure within the second line 145. Such cases may be served by configuring the lines 135, 145 such that the area ratio is at least about 100. Because the molar volume of the refrigerant vapor may be on the order of 1000 times the molar volume of the liquid refrigerant at standard conditions, a minimal pressure rise in the second line 145 may occur when the area ratio is about 1000 or greater. In the nonlimiting case that the lines 135, 145 are cylindrical, the diameter of the second line 145 may be about 20 times the diameter of the first line 135 in such embodiments.

The refrigerant, in the liquid and/or vapor phase, flows to the refrigerant reservoir 150 via the second line 145. The refrigerant reservoir 150 includes one or more separators, illustrated as separators 160a, 160b. The separators 160a, 160b are collectively referred to as separators 160, without limitation. A portion of the refrigerant vapor in the second line 145 is expected to condense on the relatively cool walls thereof. When the refrigerant enters the separator 160a, the liquid portion of the refrigerant will collect in the bottom of the separator 160a.

An intermediate line 165 has an opening 170 thereof that is below an opening 175 of the second line 145 in the separator 160a. Herein, the terms above and below, higher and lower, and similar terms indicate directions with respect to gravity. Thus, e.g., when a first opening is above a second opening, the first opening is at a greater distance from the source of gravity than is the second opening. The volume of refrigerant in the closed loop may be managed such that a liquid level 180a is usually higher than the opening 170. Thus pressure in the separator 160a, exerted by the refrigerant vapor on the liquid refrigerant, forces liquid refrigerant into the intermediate line 165.

The separator 160b receives the liquid refrigerant from the intermediate line 165. The separator 160b operates in a similar manner as the separator 160b to separate the liquid refrigerant from any gaseous refrigerant that may be received from the separator 160a. In particular, the third line 155 has an opening 171 within the separator 160b that is below an opening 172 in the intermediate line 165. The opening 171 is usually below a liquid level 180b. Thus, pressure in the separator 160b forces liquid refrigerant into the third line 155. As many additional separators may be employed as desired to minimize the amount of vapor that leaves the refrigerant reservoir 150. In some cases, a single separator, e.g. the separator 160a, may be sufficient, in which cases the separator 160b and the intermediate line 165 may be omitted. In such embodiments, the third line 155 operates to receive liquid refrigerant as described with respect to the intermediate line 165.

When the cooling system 200 includes a plurality of separators 160, as illustrated, the opening 171 is regarded as being below the opening 175 as long as for at least one of the plurality of separators 160, the opening of the line through which refrigerant flows from that separator 160 is below the opening of the line through which refrigerant flows to that separator 160.

In some embodiments, the refrigerant reservoir 150 may be located below a surface 182 of the earth. “Below a surface of the earth” encompasses embodiments in which the refrigerant reservoir 150 is underground, e.g., buried in a shaft, and embodiments in which the refrigerant reservoir 150 is underwater, e.g., submerged in a body of water such as a river, lake or pond. For brevity of discussion, for embodiments in which the refrigerant reservoir 150 is located below a surface of the earth, the refrigerant reservoir 150 is referred to herein and in the claims as “buried.”

When the refrigerant reservoir 150 is buried, a portion 185 of the second line 145 will generally be in contact with surrounding soil or water. When the portion 185 is long enough, the separator 160a (and the separator 160b, if present) may be located in an isothermal region of the ground. Such a region may be characterized as having a temperature that is relatively insensitive to seasonal fluctuation. In some cases, it is believed that the isothermal region will have a relatively constant temperature of about 10° C. Thus the ground at a sufficient depth may provide an effective heat sink for the refrigerant. Such use of the ground is commonly referred to as geothermal cooling. The use of geothermal cooling with the cooling system 110 may be particularly advantageous in various embodiments to reduce the energy required to cool the electronic system 105.

However, use of the cooling system 110 is not limited to use with geothermal cooling. In some embodiments, heat-radiating fins may be attached to the second line 145 to aid the transfer of the heat of condensation of the refrigerant therein to surrounding air. In other embodiments a water jacket may be used to cool the refrigerant. In either of these embodiments, the condensed refrigerant, and any remaining refrigerant vapor, will flow to the refrigerant reservoir 150 as previously described.

Transport of heat from the gaseous refrigerant to the environment, e.g., air above-ground, or soil or water below ground, may be enhanced by the use of an optional flow turbulence generator 190. The flow turbulence generator 190 may take the form of one or more of a vortex generator, a zig-zag or spiral portion of the second line 145, or one or more protrusions attached to the inner wall of the second line 145 configured to disrupt smooth, e.g. laminar, flow of the refrigerant vapor without imposing significant back pressure on the flow of the vapor. Turbulence produced by the flow turbulence generator 190 is expected to increase mixing of the refrigerant vapor, thereby increasing efficiency of heat transfer to soil, water or air in contact with the second line 145.

Returning to the separator 160b, the third line 155 receives liquid refrigerant therefrom and guides the refrigerant to the pump 140. An optional receiver 195 is located inline with the third line 155 between the reservoir 150 and the pump 140. The pump 140 may fail to pump if a sufficiently large pocket of vapor reaches it. The optional receiver 195 provides a backup to the separators 160 to prevent refrigerant vapor from reaching the pump 140. The receiver 195 includes an opening 195a at an inlet thereof that is higher than an opening 195b at an outlet thereof. The opening 195b is considered to be lower than the opening 195a as long as refrigerant within the receiver 195 leaves the receiver 195 at a lower level than the refrigerant enters the receiver 195. Preferably, the lower level is below a liquid refrigerant surface. Any refrigerant vapor received by the receiver 195 is expected to remain at the top of the separator. Any vapor received by the receiver 195 is expected to be transient, as it should be condense rapidly and rejoin the flow of liquid refrigerant.

In some embodiments a bubble detection system (not shown) may be used in lieu of or in addition to the receiver 195. Such a system may disable the pump 140 when bubbles are detected near the inlet of the pump 140. The bubble detection system may then re-enable the pump 140 when the refrigerant line is determined to be free of bubbles.

Optionally, a control system including a flow controller 198 may be configured to control the pump 140 and/or an optional flow valve 199 to control the flow of refrigerant through the heat exchanger 130. Flow control may serve at least two purposes.

First, the flow may be reduced when the heat load produced by the electronic system 105 falls, e.g. because of reduced loading on a function provided by the electronic system 105. Reduced refrigerant flow may be advantageous in this situation to ensure that the refrigerant vaporizes within the heat exchanger 130. While the cooling system 110 would be expected to operate in the absence of such vaporization of the refrigerant, it is expected that efficiency of heat transport is increased by the phase change from liquid to gas.

Second, flow control may be used to ensure that the temperature of the refrigerant within the heat exchanger 130 does not fall below a dew point of air circulating through the heat exchanger 130. The controller 198 may receive a signal from sensors within the heat exchanger 130 that determine temperature and relative humidity. The controller 198 may determine therefrom the dew point of the air, and control the flow of refrigerant to maintain a temperature of the refrigerant greater than the dew point. Such operation may be advantageous to reduce or eliminate condensation formed within the heat exchanger 130 that might otherwise cause corrosion or electrical shorting of components within the electronic system 105.

In some embodiments an air-cooled heat exchanger 147 is provided. The system 100 may be configured to deliver refrigerant to the air-cooled heat exchanger 147 via the second line 145 in parallel with, or alternative to, the refrigerant reservoir 150. The heat exchanger 147 may receive gaseous refrigerant from the line 145 via a directional valve 148, and may provide liquid refrigerant to the line 155 via a directional valve 156. The valves 148, 156 may be controlled, e.g. by a system controller (not shown) that senses ambient air temperature near the cooling system 110. When the ambient temperature falls below a value at which air cooling becomes more efficient or effective than, e.g., ground cooling, the controller may control the valves 148, 156 to route refrigerant through the heat exchanger 147. The heat exchanger 147 may optionally include a fan to move air thereover. Thus, for example, the cooling system 110 may rely on air cooling in winter months and ground cooling in summer months.

In the illustrated embodiment of the system 100, refrigerant may flow from the heat exchanger 147 directly to the receiver 195. In an alternate embodiment, refrigerant may flow to the intermediate line 165. In this way, the separator 160b may operate to separate refrigerant vapor generated in the heat exchanger 147 from the refrigerant stream delivered to the receiver 195.

Turning to FIG. 2, illustrated is an embodiment of a cooling system 200. The cooling system 200 includes a primary cooling loop 205 and a secondary cooling loop 210. The primary cooling loop 205 includes a first refrigerant line 215 that connects the pump 140 to the heat exchanger 130. A second refrigerant line 220 connects the heat exchanger 130 to a second heat exchanger 225. A third refrigerant line 230 connects the second heat exchanger 225 to the pump 140.

A refrigerant reservoir 235 is located in the third refrigerant line between the second heat exchanger 225 and the pump 140. Similarly to the receiver 195, the reservoir 235 has a first opening at an inlet 235a thereof that is above a second opening at an outlet 235b thereof. The reservoir 235 may operate as previously described with respect to the receiver 195 to prevent refrigerant vapor from reaching the pump 140.

The primary cooling loop 205 may be significantly shorter than the closed-loop system of FIG. 1. Thus, drag on the refrigerant is expected to be significantly less, and the pump 140 may be operated with a differential pressure less than that of the pump 140 in the system 100. In some cases, the pump 140 in the cooling system 200 may be operated with a differential pressure of 30 kPa or less while providing adequate refrigerant flow to accommodate the maximum expected cooling load imposed by the electronic system 105.

Regarding the secondary cooling loop 210, a first coolant line 240 connects the second heat exchanger 225 to a coolant pump 245. The coolant pump 245 circulates the coolant through a serpentine line 250 back to the second heat exchanger 225. The coolant may be, e.g., a water-based coolant such as a solution of water and ethylene glycol or propylene glycol.

The second heat exchanger 225 is configured to transfer heat from the refrigerant to the secondary cooling loop 210. FIG. 3 illustrates an example embodiment of the second heat exchanger 225. A first set of ports 310, 320 is configured to couple refrigerant to a first chamber 350. A second set of ports 330, 340 is configured to couple a coolant circulating in the secondary cooling loop to a second chamber 360. As the refrigerant and the coolant circulate through the second heat exchanger 225, heat from the refrigerant is absorbed by the coolant, which may then transfer the heat to a location remote from the second heat exchanger 225.

The serpentine line 250 may be configured in any manner suitable to transfer heat from the coolant to the environment. In a nonlimiting example, the serpentine line 250 is located under the surface 182 of the earth. The serpentine line 250 may be a portion of a water-based geothermal radiator previously installed to cool the electronic system 105, and retrofitted to include the primary cooling loop 205. The serpentine line 250 may include segments 255 extending tens or hundreds of feet into the ground to effect heat transfer thereto.

Retrofitting of the secondary cooling loop 210 in the manner described may be advantageous in situations in which it is desirable to employ a standardized heat exchanger 130 design. A standard design may provide the aforementioned advantages of flow control and condensation reduction, while taking advantage of previously installed cooling infrastructure at a remote site at which the electronic system 105 is installed. If desired, a control system as previously described may be integrated with the primary cooling loop 205 to control a temperature of the refrigerant in the heat exchanger 130.

FIG. 4A describes a method 400 that may be employed, e.g. to manufacture the cooling system 110 or the cooling system 200. Without limitation the method 400 is described using elements of the cooling system 110 for illustration. The steps of the method 400 may be performed in the order presented or in another order.

In a step 410, the heat exchanger 130 is configured to absorb heat from a heat source, e.g., the electronic system 105.

In a step 420 the heat exchanger 130 is connected to the pump 140 via the first line 135, and to the refrigerant reservoir 150 via the second line 145.

In a step 430 the reservoir 150 is connected to the pump 140 via the third line 155. The third line 155 includes the opening 170 within the reservoir 150 that is above the opening 175 of the second line 145 within the reservoir 150.

In the steps 410-430 the first, second and third lines are capable of carrying a refrigerant.

FIG. 4B describes optional additional steps 440-490 of the method 400. The steps 440-490 may be performed, if at all, in the order presented or in another order.

In a step 440, the receiver 195 is located in the third line 155 between the reservoir 150 and the pump 140. The receiver 195 is configured to selectively allow a refrigerant liquid phase to flow to the pump 140.

In a step 450 the flow turbulence generator 190 is configured to induce turbulence in a vapor phase flow of the refrigerant in the second line 145.

In a step 460 the control system 198 is configured to control refrigerant flow through the heat exchanger 130 to maintain a temperature of the refrigerant within the heat exchanger 130 above a dew point of air flowing over the heat exchanger 130.

In a step 470 the air-cooled heat exchanger 147 is configured to receive a refrigerant via the second line 145, and to return the refrigerant to the pump 140.

In a step 480, the cooling system 110 is charged with a refrigerant. The refrigerant may be any of the aforementioned class of refrigerants. Optionally the refrigerant has a global warming potential of about 10 or less.

In a step 490, the pump 140 is configured to operate with a differential pressure of about 70 kPa or less. When so configured, the pump when operating circulates the refrigerant with negligible compression.

Those skilled in the art to which this application relates will appreciate that other and further additions, deletions, substitutions and modifications may be made to the described embodiments.

What is claimed is:

1. A cooling system, comprising:
a heat exchanger;
a refrigerant reservoir;
a pump connected to said heat exchanger by a first line;
a second line connecting said heat exchanger to said reservoir; and
a third line connecting said reservoir to said pump, said third line having an opening within said reservoir that is below an opening of said second line within said reservoir,
wherein said first, second and third lines are capable of carrying a refrigerant.

2. The system as recited in claim 1, further comprising a receiver located in said third line between said reservoir and said pump, and configured to selectively allow a refrigerant liquid phase to flow to said pump.

3. The system as recited in claim 1, further comprising flow turbulence generator configured to induce turbulence in a flow of refrigerant vapor within said second line.

4. The system as recited in claim 1, wherein said second line has a cross-sectional area larger than a cross-sectional area of said first line.

5. The system as recited in claim 1, further comprising a control system configured to control a flow of a refrigerant through said heat exchanger to maintain a temperature of said refrigerant above a dew point of air flowing over said heat exchanger.

6. The system as recited in claim 1, further comprising an air-cooled heat exchanger configured to receive a refrigerant via said second line, and to return said refrigerant to said pump.

7. The system as recited in claim 1, further comprising a refrigerant within said heat exchanger having a global warming potential (GWP) of about 10 or less.

8. The system as recited in claim 1, wherein said pump is configured to pump a refrigerant with a pressure differential of about 70 kPa or less.

9. A method, comprising:
configuring a heat exchanger to absorb heat from a heat source, including:
connecting said heat exchanger to a pump via a first refrigerant line, and to a refrigerant reservoir via a second refrigerant line; and
connecting said reservoir to said pump via a third line, said third refrigerant line have an opening within said reservoir that is below an opening of said second line within said reservoir,
wherein said first, second and third lines are capable of carrying a refrigerant.

10. The method as recited in claim 9, further comprising locating a receiver in said third line between said reservoir and said pump, said receiver being configured to selectively allow a refrigerant liquid phase to flow to said pump.

11. The method as recited in claim 9, further comprising configuring a flow turbulence generator to induce turbulence in a vapor phase flow of a refrigerant in said second line.

12. The method as recited in claim 9, wherein said second line has a cross-sectional area larger than a cross sectional area of said third line.

13. The method as recited in claim 9, further comprising configuring a controller to control a refrigerant flow through said heat exchanger to maintain a temperature of said refrigerant within said heat exchanger above a dew point of air flowing over said heat exchanger.

14. The method as recited in claim 9, further comprising configuring an air-cooled heat exchanger to receive a refrigerant via said second refrigerant line, and to return said refrigerant to said pump.

15. The method as recited in claim 9, further comprising charging said closed-loop system with a refrigerant having a global warming potential (GWP) of about 10 or less

16. The method as recited in claim 9, further comprising configuring said pump to operate with a differential pressure of about 70 kPa or less.

17. A cooling system, comprising:
a primary cooling loop comprising:
a first heat exchanger;
a pump connected to said first heat exchanger via a first refrigerant line;
a second heat exchanger connected to said first heat exchanger via a second refrigerant line, and to said pump via a third refrigerant line; and
a refrigerant reservoir located in said third refrigerant line between said second heat exchanger and said pump, said reservoir having a first opening at an inlet thereof that is above a second opening at an outlet thereof,
wherein said first, second and third lines are configured to circulate a refrigerant, and
wherein said second heat exchanger is configured to transfer heat from said refrigerant to a secondary cooling loop.

18. The cooling system as recited in claim 17, wherein said secondary cooling loop is configured to transfer said heat to a geothermal heat radiator.

19. The cooling system as recited in claim 17, wherein said secondary cooling loop includes a coolant that comprises water.

20. The cooling system as recited in claim 17, wherein said pump is configured to pump a refrigerant with a pressure differential of about 30 kPa or less.
